(19) United States
(12) Patent Application Publication
(10) Pub. No.: US 2011/0219055 A1
(43) Pub. Date: Sep. 8, 2011

(54) SOCIAL BOOKMARKING FOR INTERACTIVE SERVICES

(75) Inventors: Mark Bailey, Hawthorne, NY (US); James E. Christensen, Hawthorne, NY (US); Jason B. Ellis, Hawthorne, NY (US); Thomas D. Erickson, South Minneapolis, MN (US); Robert G. Farrell, Hawthorne, NY (US); Wendy A. Kellogg, Hawthorne, NY (US)

(73) Assignee: INTERNATIONAL BUSINESS MACHINES CORPORATION, Armonk, NY (US)

(21) Appl. No.: 12/715,921

(22) Filed: Mar. 2, 2010

(51) Int. Cl. G06F 15/16

(52) U.S. Cl. 709/202; 709/203

(57) ABSTRACT

A service includes a server for operating system that supports parametric personalized social (PPS) bookmarks. The server includes a PPS bookmark creator configured to determine information gathered at a point in an automated dialog after a request to create a PPS bookmark is received. The server also includes a PPS bookmark executer configured to, upon receipt of a PPS bookmark identifier, return to the point in the automated dialog and recreate at least a part of the information gathered.

### BACKGROUND

The present invention relates to computing and, in particular, to creating bookmarks to certain locations within a computing system.

Interactive services such as computer guided forms and Interactive Voice Response (IVR) services, allow for the automated collection of data. The collected data may be used for any number of different applications. For example, the collected data could be used to verify a credit card for a purchase or could be used to find other information in, for example, an IVR.

In more detail, an IVR service is software that allows a computer system to detect voice and keypad inputs and provide an audio response. This is used in a variety of domains including telecommunications, help desks, weather forecasts, banking, order placement, booking airline tickets, and more. IVRs can run on private networks (PBXs—private branch exchanges) or the public switched telephone network. An IVR is implemented as a software system running on a computer that provides audio interaction through a set of menus. A menu can consist of: generating any audio prompt; accepting any audio or phone keypad input; performing any computation (e.g., speech recognition); storing any data (within or across sessions. A session ends when the call ends). The system may generate an audio response based on the inputs in some cases. The audio prompts and responses can include voice, DMTF tones that a telephone keypad makes when pressed, music and more. In short, an IVR may provide a telephony interface to a computer system.

Computer systems generally may provide the same types of abilities through a textual or graphical user interface. In such systems, as a user progresses through, for example, providing information to a form, individual pieces of information are stored.

Regardless of the system in which a user is operating, it takes time to navigate a path through an interactive system. To return to a specific location along the path, at least two options exist. The first is to start the process over. The second, and more expedient, is to create a bookmark that links directly to the desired information. In a computing environment, a bookmark includes the location to the information. On the web, the standard for encoding locations on a local or remote computer system is Uniform Resource Identifier (URI). A user can send a URI to some information to a Recipient, over email or other means, and the recipient can use the URI to get the information. All modern web browsers include bookmark features. Bookmarks are normally accessed through a menu in the user's web browser, and folders are commonly used for organization. In addition to bookmarking methods within most browsers, many external applications offer bookmark management.

With the advent of social bookmarking, shared bookmarks have become a means for users sharing similar interests to pool the locations of web resources, or to store their bookmarks in such a way that they are not tied to one specific computer or browser. Web-based bookmarking services let users save bookmarks on a remote web server, accessible from anywhere.

### SUMMARY

According to one embodiment of the present invention, a service that includes a server for operating system that supports parametric personalized social (PPS) bookmarks is provided. The server includes, the server including a PPS bookmark creator configured to determine information gathered at a point in an automated dialog after a request to create a PPS bookmark is received and a PPS bookmark executer configured to, upon receipt of a PPS bookmark identifier, return to the point in the automated dialog and recreate at least a part of the information gathered.

According to another embodiment of the present invention, a method of operating an automated dialog at a server is provided. The method of this embodiment includes receiving a parametric personalized social (PPS) bookmark creation request at the server from a user; and creating a PPS bookmark at the server, creating including: recording a location in the dialog where the creation request was received; and recording information received from the user and required to reach the location.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 shows an example of a PPS bookmark system according to one embodiment of the present invention;

FIG. 2 shows an example of computing device on which one or more embodiments of the present invention may be implemented;

FIG. 3 is a flow chart showing one method of creating a PPS bookmark according to one embodiment;

FIG. 4 is a flow chart showing how a PPS bookmark may be utilized according to one embodiment;

FIG. 5 shows a progression of screens that may be presented to user by a service during a computer-based interactive dialog; and

FIG. 6 shows a progression of screens that may occur after a PPS bookmark has been formed on the screen of the user who created the PPS bookmark.

### DETAILED DESCRIPTION

Existing bookmarks are essentially pointers to a web document or program that are meant to recall a specific web page or to execute a program with fixed data that then outputs a web page. Disclosed herein are parametric personalized social (PPS) bookmarks that may improve on shortcomings in existing bookmarks.

In one embodiment, PPS bookmarks as disclosed herein may essentially be pointers to a specific step in a personalized dialog between a user and an interactive service running on a server. Personalization of the services' dialog is accomplished by the server's use of the user's personal information to establish the state at the requested step in the dialog and then continue from that point. PPS bookmarks may be implemented over a data network using a computer or over a voice network using a telephone.

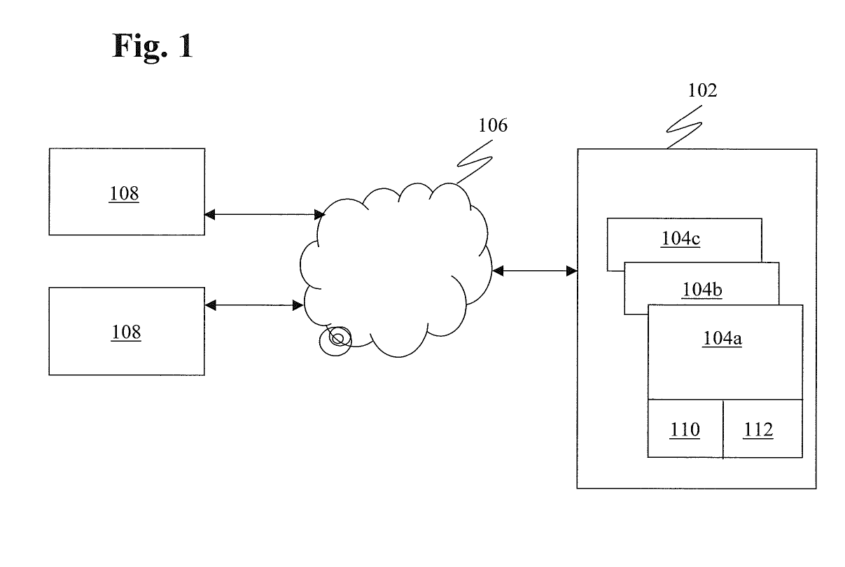

FIG. 1 shows an example of system 100 on which embodiments of the present invention may be implemented. The system 100 includes an interactive service 102. The interactive service 102 may be running on one or more servers 104. As shown, the service 102 is running on servers 104a, 104b, and 104c but this is merely illustrative. Any combination of servers (or a single server) shall be referred to herein as “servers” or “server.”

In one embodiment, the servers 104 may be programmed to create and reuse PPS bookmarks and PPS bookmarks are specific to a particular service. Of course, this does not require the PPS bookmarks be specific to a specific server 104. In one embodiment, the interactive service 102 is computer-based interactive service. In another embodiment, the interactive service 102 is an interactive voice response (IVR) system.

Regardless, the server 104 may include a parametric personalized social (PPS) bookmark creator 110 configured to determine information gathered at a point in an automated dialog after a request to create a bookmark is received. The server 104 may also include a PPS bookmark executer 112 configured to, upon receipt of a PPS bookmark, return to the point in the automated dialog and recreate at least a part of the information gathered. Enough of the recreated information may be gathered that the dialog can proceed without user input. In such a case, the dialog will proceed automatically and complete.

The service 102 is coupled to a communications network 106. The communications network 106 may be a cellular network in one embodiment. For example, the communications network 106 could be a GSM, TDMA, 2G, 3G or 4G wireless network. The communications network 106 could also be a wireless data network such as WIMAX or 802.11. Of course, the communications network 106 could be wireless or physical. In one embodiment, the communications network 106 may be an intranet or the Internet.

The system 100 may also include one or more client devices 108. The client devices 108 may communicate with the service 102 and with one another via the communications network 106. In one embodiment, the client device 108 is a computing device. In another embodiment, the client device 108 may be telephone.

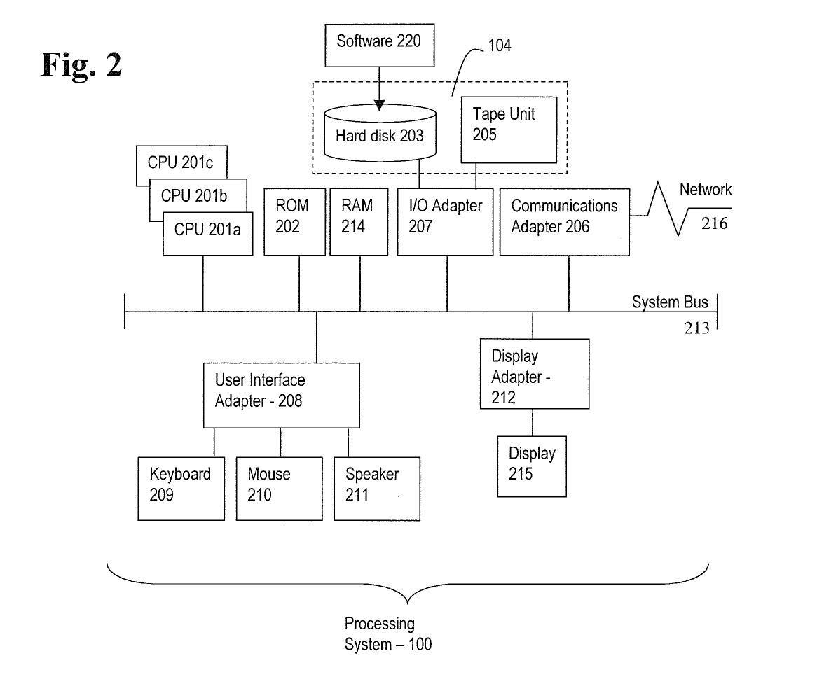

FIG. 2 shows an example of a computing system 200 that may be utilized as a client device (in the event it is a computing device) or as server. The system 200 has one or more central processing units (processors) 201a, 201b, 201c, etc. (collectively or generically referred to as processor(s) 201). In one embodiment, each processor 201 may include a reduced instruction set computer (RISC) microprocessor. Processors 201 are coupled to system memory 214 and various other components via a system bus 213. Read only memory (ROM) 202 is coupled to the system bus 213 and may include a basic input/output system (BIOS), which controls certain basic functions of system 200.

FIG. 2 further depicts an input/output (I/O) adapter 207 and a network adapter 106 coupled to the system bus 213. I/O adapter 207 may be a small computer system interface (SCSI) adapter that communicates with a hard disk 203 and/or tape storage drive 205 or any other similar component. I/O adapter 207, hard disk 203, and tape storage device 205 are collectively referred to herein as mass storage 204. A network adapter 206 interconnects bus 213 with an outside network 216 enabling system 200 to communicate with other such systems. A screen (e.g., a display or monitor) 215 is connected to system bus 213 by display adaptor 212, which may include a graphics adapter to improve the performance of graphics intensive applications and a video controller. In one embodiment, adapters 207, 206, and 212 may be connected to one or more I/O busses that are connected to system bus 213 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 213 via user interface adapter 208 and display adapter 212. A keyboard 209, mouse 210, and speaker 211 all interconnected to bus 213 via user interface adapter 208, which may include, for example, a Super I/O chip integrating multiple device adapters into a single integrated circuit. Of course, other inputs, such as a digital camera or digital video camera (or other means of supplying one or more images to a in a digital format) and a microphone may be included as additional input devices.

Thus, as configured in FIG. 2, the system 200 includes processing means in the form of processors 201, storage means including system memory 214 and mass storage 204, input means such as keyboard 109 and mouse 110, and output means including speaker 211 and display 215. In one embodiment, a portion of system memory 214 and mass storage 204 collectively store an operating system such as the AIX® operating system from IBM Corporation to coordinate the functions of the various components shown in FIG. 2.

It will be appreciated that the system 100 can be any suitable computer or computing platform, and may include a terminal, wireless device, information appliance, device, workstation, mini-computer, mainframe computer, personal digital assistant (PDA) or other computing device. It shall be understood that the system 100 may include multiple computing devices linked together by a communication network. For example, there may exist a client-server relationship between two systems and processing may be split between the two.

Examples of operating systems that may be supported by the system 100 include Windows 95, Windows 98, Windows NT 4.0, Windows XP, Windows 2000, Windows CE, Windows Vista, Mac OS, Java, AIX, LINUX, and UNIX, or any other suitable operating system. The system 100 also includes a network interface 206 for communicating over a network 216. The network 216 can be a local-area network (LAN), a metro-area network (MAN), or wide-area network (WAN), such as the Internet or World Wide Web.

Users of the system 200 can connect to the network through any suitable network interface 216 connection, such as standard telephone lines, digital subscriber line, LAN or WAN links (e.g., T1, T3), broadband connections (Frame Relay, ATM), and wireless connections (e.g., 802.11(a), 802.11(b), 802.11(g)).

As disclosed herein, the system 200 includes machine-readable instructions stored on machine readable media (for example, the hard disk 204) for capture and interactive display of information shown on the screen 215 of a user. As discussed herein, the instructions are referred to as “software” 220. The software 220 may be produced using software development tools as are known in the art. The software 120 may include various tools and features for providing user interaction capabilities as are known in the art.

In some embodiments, the software 220 is provided as an overlay to another program. For example, the software 220 may be provided as an “add-in” to an application (or operating system). Note that the term “add-in” generally refers to supplemental program code as is known in the art. In such embodiments, the software 220 may replace structures or objects of the application or operating system with which it cooperates.

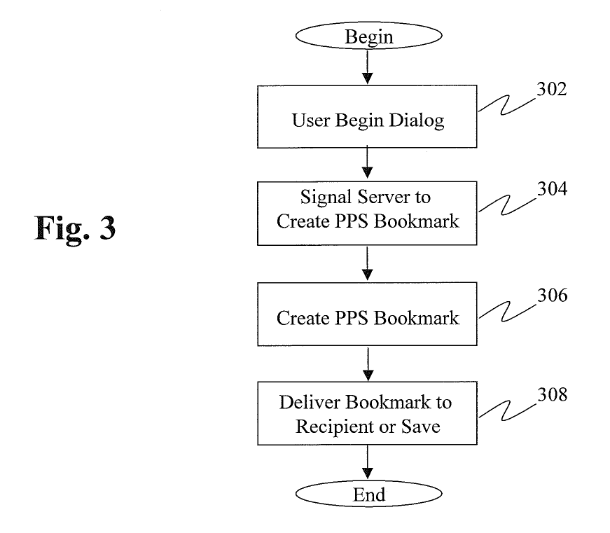

FIG. 3 shows a method of creating a PPS bookmark according to one embodiment. At a block 302, a user of an interactive data or voice service navigates an interactive dialog provided by the interactive service in a normal manner. At some point in the interactive dialog, the user decides to create a PPS. As a result of this decision, at a block 304, the user signals the server to create a PPS bookmark. This may be accomplished, for example, by selecting a “create” option provided by a service or computing device or pressing a special PPS key sequence on a phone coupled to an IVR system to create a PPS bookmark.

At a block 306, the server creates a PPS bookmark that captures the state of the dialog. This may include, for example, storing data acquired from the user or computed during the dialog as part of the PPS bookmark. Storing the data may include, for example encapsulating the state of the dialog and any parameters (dialog-specific information about where personalized data is required when the “executor” runs (executes) the PPS bookmark. The state of the dialog may include, in one embodiment, a listing (or form) of all of the information required to reach that state. For voice services, other techniques may be utilized including, for example, assigning an access number to a location that stores the data. At a block 308, the PPS bookmark may be delivered to the creator of the PPS bookmark or to another user of the service.

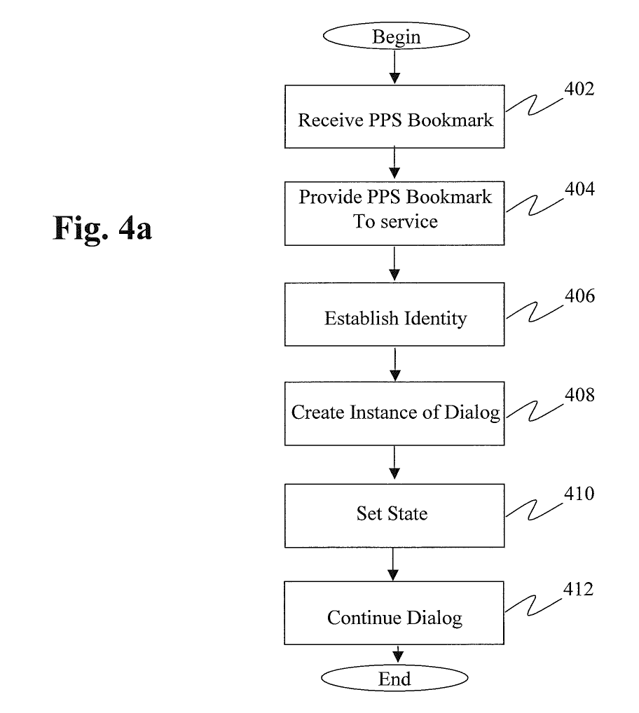

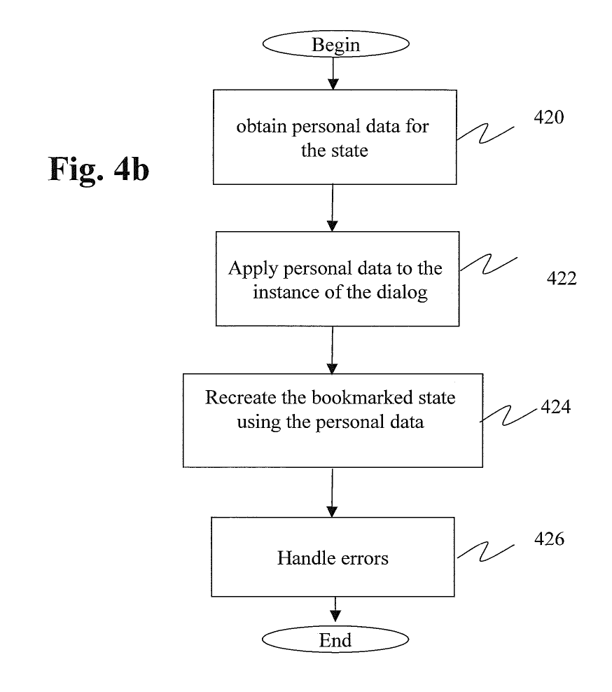

FIG. 4a is a block diagram showing how a PPS bookmark may be utilized according to one embodiment. At a block 402 the PPS bookmark is received by a user. The user may be creator of the PPS bookmark or another user. The PPS bookmark may be received at the request of the creator in one embodiment. That is, the creator may request that the bookmark by provided to them or to another user (or both). In another embodiment, the user may receive the bookmark as part of a selection process. For example, a user may browse the service for previously created PPS bookmarks and select one. In another embodiment, the PPS bookmark in an IVR system may have a recorded label that may be selected by a user.

At a block 404 the user may present the PPS bookmark to the service. This may include, for example, clicking a link in a computing environment or entering an access code into an IVR system.

At a block 406 the server establishes (and may confirm) the identity of the user.

At a block 408, the server creates an instance of the referenced interactive dialog. Creation of the instance may include determining the stage in a dialog (state) that was reached. This information may be included in, for example, the PPS bookmark itself. Creation of the instance may also include determining (and obtaining) the information required for the particular state.

At a block 410, the server sets the state of said dialog using the parameters contained in the PPS bookmark. Further details of block 410 are described with respect to FIG. 4b.

At a block 412, the interactive dialog to “proceed normally” from the state established by the above steps.

FIG. 4b is a block diagram showing how a PPS bookmark sets the state of a dialog using the parameters contained in the PPS bookmark according to one embodiment. At a block 420, the server obtains the personal information of the user. This personal information may be stored with the PPS bookmark (or by the service generally). The state may be set using any personal information of the user that is stored with the PPS (or by the service generally) and generating a new dialog/form there from. In some instances, generating a new form may require that the user confirm existing information or add additional information. For example, if the user was the creator of the PPS bookmark, the service may need only confirm that the information contained in PPS bookmark or stored by the service that it utilizes to the set the state is correct. This may include presenting the user with a pre-filled form of the required information that the user may edit if desired. In the instance that this is not the user that created the bookmark, the service may need to collect any items of information for the state from this user.

At a block 422, the server applies the obtained personal information to the instance of the interactive dialog. This may involve, for example, finding where any parameters are used in said interactive dialog and modifying portions of said instance of the interactive dialog by substituting portions of the obtained personal information for the parameters.

At a block 424, the server recreates the bookmarked state. The bookmarked state is the state of the interactive dialog after the bookmark was created at 306. This may include obtaining additional information stored by the PPS bookmark itself or by the service generally.

At block 426, the server checks to see if the dialog can be continued. In some cases, the server may not be able to fully recreate and personalize the bookmarked state. In these cases, the server may signal to user and not continue the dialog at block 412 (FIG. 4a).

The PPS bookmarks described herein may have many beneficial uses. For example, in the case of personal use, a user may be interacting with an interactive service and want to return later to complete the dialog. The dialog involves data that could change by the next call. Accordingly, Sam may be given the option to update any prior received information. In the case of collaborative use, a user may share a bookmark with another user who has different data (location, credit cards, age). In such a case, the other user may be prompted to enter the information required at that particular state. The present invention may satisfy both situations as described in the following examples.

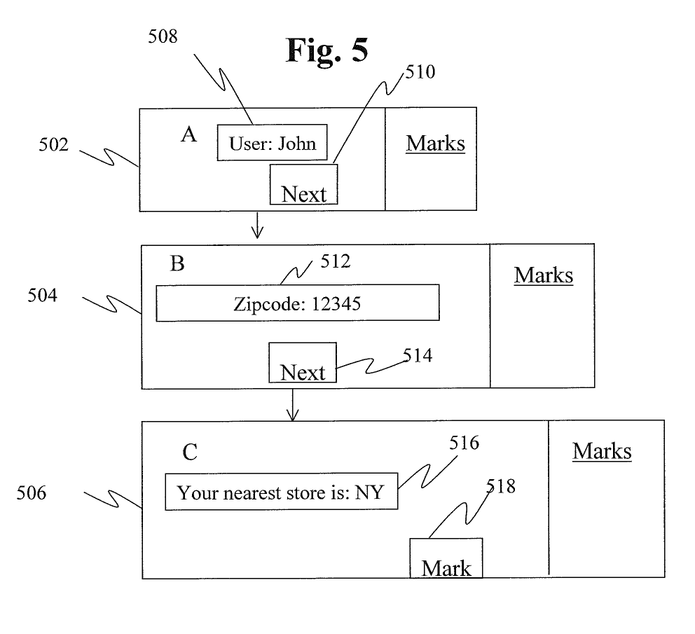

FIG. 5 shows a progression of screens that may be presented to user by a service during a computer-based interactive dialog. In this example, assume that based on the zip-code, the service provides the location of the nearest store to the user.

The first screen 502 may present a user a first information gathering block 508. In this example, the first information gathering block 508, in this example, may receive the user's name. Of course, any information could be gathered by any of the information gathering blocks described herein. In one embodiment, some or all of these information gathering blocks may be automatically filled by the service. The first screen 502 may also include “next” button 510 that causes the information in the first information gathering block to be stored and causes the dialog to progress to the second screen 504.

The second screen 504 may present the user a second information gathering block 512 to receive (or otherwise fill in) the users zip code. The second screen 504 may also include “next” button 514 that causes the information in the second information gathering block to be stored and causes the dialog to progress to the third screen 506.

Based on the information (name and zipcode) received in the first two screens (502 and 504) a process may be employed to determine the closest store to the user. This information may be displayed in the answer block 516 of the third screen 506. The third screen 506 (as well as any other screen) may include a “Mark” button 518 that, when selected, causes a PPS bookmark as described herein to be created. In this case, the bookmark may link to the third screen 506 and require that a user enter their name (if the user is not the one who created the PPS bookmark) and enter or verify a zipcode. For purposes of this explanation, the PPS bookmark just created shall be referred to as “PPS bookmark 1” hereinafter. PPS bookmark 1 may be shown in subsequent viewings pages of the service.

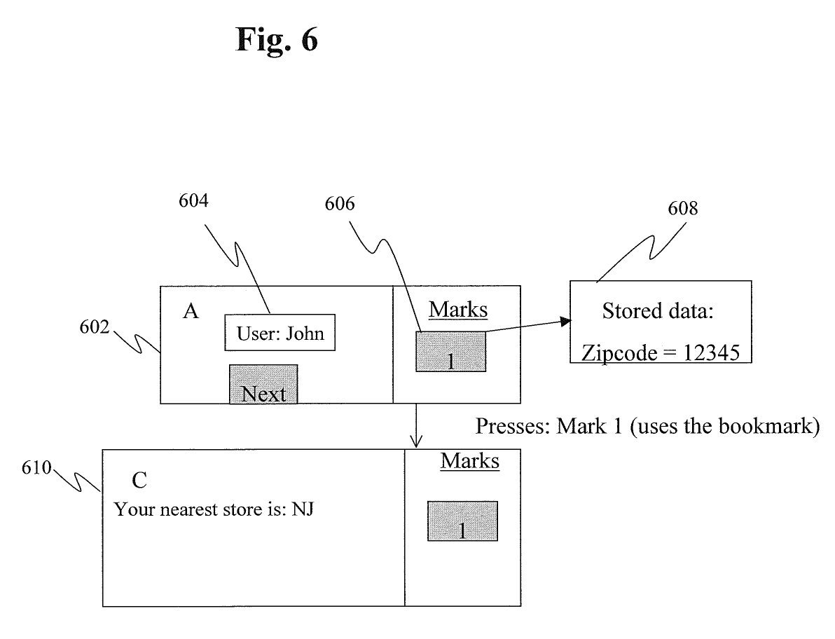

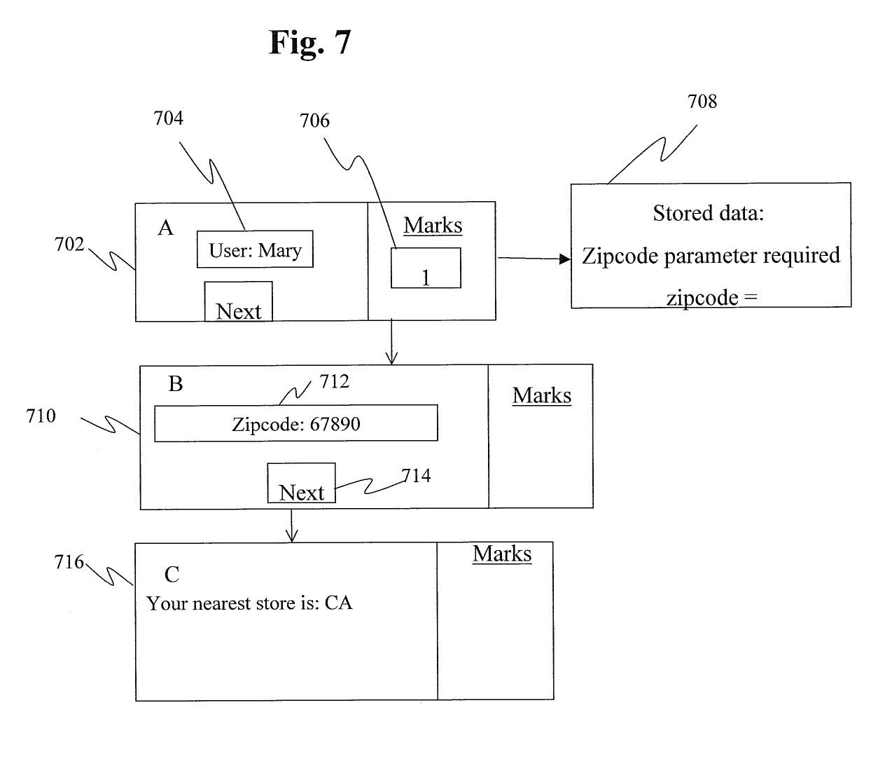

FIG. 6 shows a progression of screens that may occur after PPS bookmark 1 has been formed on the screen of the user who created PPS bookmark 1. For example, assume that the same user returns to the service (or any time after the user has created the bookmark) and a new store has opened that is closer than the store originally found. A first screen 602 may be presented that indicates that the user is John (first information block 604) and that PPS bookmark 1 has been created. In the instance that John presses the PPS bookmark 1 button 606, PPS bookmark 1 determines that John's zipcode is needed to enter the state of the PPS bookmark. Thus, the server determines either from s information stored in the PPS bookmark 1 (block 608), that zipcode is a needed parameter. The server then looks up John's zipcode and finds it is 12345. In an additional step, the John's zipcode may be verified or confirmed by John. In cases when PPS bookmarks are shared, John's personal information may be encrypted or otherwise hidden when stored with in the PPS bookmark, or stored in a personal user profile accessible only to John. John inspect the PPS bookmark and not want to create the bookmark if it will include his personal information. With this information, the results screen 610 may be created. This differs from the previous Fig. because there was no need to go through the second screen 504.

FIG. 7 shows a progression of screens that may occur once the user (John) sends PPS bookmark 1 (706) to a second user (Mary). Mary may wish to find the store closest to her. Mary first selects the bookmark 706 on a first screen 702 that identifies the user as Mary. Note that the bookmark may include a title, creation date, or other information added by John, the bookmark creator, or automatically, sufficient for Mary to determine whether or not she wants to use the bookmark. Any number of other methods may be used to describe the bookmark to the user. For example, the user may be able to inspect the steps in the dialog or the screens used. The service determines that it does not have Mary's zip code and then generates a dialog screen (form) to collect the information as shown on screen 710 where the zipcode has been received from mart'. When Mary presses the next button 714, screen 716 is created based on the received information. In this example, the result is the location of the nearest store to Mary.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A service comprising:
a server for operating system that supports parametric personalized social (PPS) bookmarks, the server including:
a PPS bookmark creator configured to determine information gathered at a point in an automated dialog after a request to create a PPS bookmark is received; and
a PPS bookmark executer configured to, upon receipt of a PPS bookmark identifier, return to the point in the automated dialog and recreate at least a part of the information gathered.

2. The service of claim 1, wherein the server is configured to provide an interactive voice response (IRV) system.

3. The service of claim 2, in combination with a telephone.

4. The service of claim 3, wherein the telephone and the server communicate via a telephone communications network.

5. The service of claim 3, wherein the PPS bookmark identifier is input on a keypad.

6. The service of claim 1, wherein the server is configured to operate a computer based dialog.

7. The service of claim 6, in combination with a client computing device.

8. The service of claim 6, wherein the PPS bookmark includes a token that includes information received from the user required to reach the point in the dialog.

9. The service of claim 1, further including:
a communications network coupled to the server.

10. A method of operating an automated dialog at a server, the method comprising:
receiving a parametric personalized social (PPS) bookmark creation request at the server from a user; and
creating a PPS bookmark at the server, creating including:
recording a location in the dialog where the creation request was received; and
recording information received from the user and required to reach the location.

11. The method of claim 10, further comprising:
forwarding the PPS bookmark to a second user, the second user being different than the first user.

12. The method of claim 11, further comprising:
receiving a return to dialog request from the second user, the return to dialog request causing the server to return to the location in the dialog.

13. The method of claim 12, wherein, in order to return to the location, the server requires that the second user provide some or all of the information required to reach the location in the dialog.

14. The method of claim 10, wherein the request is received from a computing device.

15. The method of claim 10, wherein the request is received from a telephone.

16. The method of claim 15, wherein the request includes a series of keypad entries.

17. The method of claim 10, wherein the PPS bookmark includes a token.

18. The method of claim 10, wherein the request is an audio input.
